(19) United States
(12) Patent Application Publication
(10) Pub. No.: US 2008/0012920 A1
(43) Pub. Date: Jan. 17, 2008

(54) Image recording apparatus

(75) Inventor: Masashi Matsuda, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/825,344

(22) Filed: Jul. 6, 2007

(30) Foreign Application Priority Data
Jul. 14, 2006 (JP) 2006-194657

(51) Int. Cl. B41J 2/01

(52) U.S. Cl. 347/104

(57) ABSTRACT

An image recording apparatus according to the present invention has a feeding unit, a conveying mechanism having at least a platen unit, an image recording unit, a maintenance mechanism, and a first discharge unit, wherein when recording an image, the maintenance mechanism is placed on the opposite side of the image recording unit through a recording medium conveying route in the conveying mechanism, at least one of the upstream side and downstream side of a recording medium conveying direction in the platen unit.

### CROSS-REFERENCE TO RELATED APPLICATIONS

This application is based upon and claims the benefit of priority from prior Japanese Patent Application No. 2006-194657, filed Jul. 14, 2006, the entire contents of which are incorporated herein by reference.

### BACKGROUND OF THE INVENTION

1. Field of the Invention

The present invention relates to an image recording apparatus having a maintenance mechanism which moves to the position of a head nozzle when performing maintenance of the head.

2. Description of the Related Art

Generally, an image recording apparatus records an image with high quality by preventing clogging of an ink-jet nozzle. To keep high image quality, an image recording apparatus periodically cleans a nozzle at every certain number of recording medium, such as paper sheets or OHP transparencies. Further, an image recording apparatus forcibly cleans a nozzle regardless of the number of recorded medium.

When a nozzle is not used for a long time, ink adhering inside or around a nozzle is dried and coagulated, and a nozzle is clogged even if an image recording apparatus cleans a nozzle. Therefore, in an image recording apparatus, a cap is used to cover a nozzle, and a nozzle is shut off from the outside air, to prevent drying of the area around a nozzle that is the cause of clogging. An image recording apparatus is generally provided with a maintenance mechanism, which shuts off a nozzle from the outside air while not recording, as well as cleaning a nozzle.

In recent years, an image recording apparatus is provided with a line head to increase a recording speed. A line head is composed of one long head, or two or more short heads fixed and arranged in the width equivalent to or larger than the width of a recording medium. Such an image recording apparatus having a line head is faster in a recording speed than a serial type image recording apparatus which records an image by ejecting ink to a recording medium by reciprocating in the width direction of a recording medium. A line head type image recording apparatus can quickly record an image. With respect to such a line head, an ink-jet recording apparatus having a maintenance mechanism for performing the above-mentioned maintenance is disclosed in Jpn. Pat. Appln. KOKAI Publication Nos. 09-57988 and 2005-067127.

FIG. 14 shows an ink-jet recording apparatus disclosed in the Publication No. 09-57988.

In a recording medium conveying section (conveying mechanism) 101, a conveying belt 110 is hung over a pair of belt rollers 108 and 109, and the conveying belt 110 is moved in the direction of the arrow. In a recording section 102, line heads of four colors, black (K), cyan (C), magenta (M) and yellow (Y) are provided. In each line head, a number of nozzles are arranged on the surface opposite to the conveying mechanism 101, in the width equivalent to or larger than the width of a recording medium. The recording section 102 is supported by a support member as one body in the portion close to the top.

The support member is provided with a supporter 119 having a through hole 118 consisting of a female screw, as one body. In the through hole 118, a drive shaft 120 consisting of a male screw is penetrating. The drive shaft 120 is directly connected to a drive motor 121. When the drive motor 121 rotates, the drive shaft 120 rotates, and the recording section 102 moves up and down with respect to the conveying belt surface of the conveying mechanism 101.

In a capping section (maintenance mechanism) 103, a cap is provided to cover the nozzle surface of the recording section 102 airtight. The maintenance mechanism 103 is located in the downstream side of the conveying mechanism 101, which becomes a home position shown in the drawing.

A timing belt 177 is hung over a pair of pulleys 175 and 176 is fixed to the maintenance mechanism 103. A drive motor 178 is fixed to the pulley 175. When the drive motor 178 rotates, the timing belt 177 rotates, and the maintenance mechanism 103 moves to the recording section 102.

In the above-mentioned ink-jet recording apparatus, the nozzle provided in the recording section 102 ejects an ink drop, and after recording an image, the drive motor 121 rotates first, and the drive shaft 120 raises the recording section 102. Then, the drive motor 178 rotates, and the timing belt 177 rotates. Then, the maintenance mechanism 103 placed at the home position moves to a position opposite to the nozzle surface of the recording section 102, and then the recording section 102 moves down. Then, a not-shown cap provided inside the maintenance mechanism 103 covers the nozzle surface.

When a not-shown suction pump provided in the maintenance mechanism 103 is operated in this state, the cap inside goes into a negative pressure state, and ink is forcibly drawn from the nozzle, and an ink eject/recovery operation is performed.

FIGS. 15A and 15B show an ink-jet recording apparatus disclosed in the Jpn. Pat. Appln. KOKAI Publication No. 2005-067127.

In a recording medium conveying section (conveying mechanism) 221, conveying belts 238a and 238b are provided. Above the conveying mechanism 221, line heads 222a and 222b are provided. At the position opposite to (right under) the line heads 222a and 222b, the conveying belts 238a and 238b are not provided, and an ejection performance maintenance mechanism (maintenance mechanism) is provided. When the image recording operation is finished, the maintenance mechanism rises, and a cap member provided in the maintenance mechanism covers the nozzle surface of the line heads 222a and 222b. A suction operation is performed in this state, and ink is forcibly drawn from the nozzle, and an ink eject/recovery operation is performed.

The ink-jet recording apparatus disclosed in the Jpn. Pat. Appln. KOKAI Publication No. 09-57988 does not move the conveying mechanism 101 when performing the ink eject/recovery operation, and moves the maintenance mechanism 103 to the position opposite to the line head of the raised recording section 102.

However, in this configuration, the ink-jet recording apparatus moves the recording section 102 down to the image recording position, after the ink eject/recovery operation is finished. Thus, the ink-jet recording apparatus may break a meniscus formed on the nozzle surface of the line head. This is apt to cause failure of ink ejection.

Moreover, the ink-jet recording apparatus disclosed in the Jpn. Pat. Appln. KOKAI Publication No. 2005-067127 performs capping the nozzle surface of the line heads 222a and 222b, or ink eject/recovery operation, only by moving up/down the maintenance mechanism without moving the conveying mechanism 221 and line heads.

However, in this configuration, the conveying belts 238a and 238b do not exist at the positions opposite to the line heads 222a and 222b. Namely, the conveying mechanism conveys the recording medium by the conveying belts 238a and 238b. Thus, when the conveying mechanism conveys the recording medium, the recording medium may be moved in a skew, decreasing a conveying accuracy.

### BRIEF SUMMARY OF THE INVENTION

The present invention provides an image recording apparatus, which can keep the meniscus in a good condition, and exactly conveys a recording medium, by performing maintenance of a nozzle by moving a maintenance mechanism to a position opposite to a line head, without moving a line head, when performing an ink eject/recovery operation (maintenance).

According to an aspect of the invention, there is provided an image recording apparatus comprising a feeding unit to feed a recording medium; a conveying mechanism having at lest a platen unit to convey a recording medium supplied by a feeding unit; an up-and-down mechanism to move up and down a platen unit; an image recording unit which is placed opposite to a platen unit, and provided with a line head for recording an image by ejecting ink from nozzles to a recording medium conveyed; a maintenance mechanism to perform maintenance for nozzles of a line head; a maintenance moving mechanism to move a maintenance mechanism to a position opposite to a line head; and a discharge unit to discharge the recording medium recorded by the image recording unit, with the last recorded side turned up, wherein when recording an image, the maintenance mechanism is placed on the opposite side of the image recording unit through a recording medium conveying route in the conveying mechanism, at least one of the upstream and downstream of a recording medium conveying direction in the platen unit.

According to another aspect of the invention, there is provided an image recording apparatus comprising a feeding unit to feed a recording medium; a conveying mechanism having at lest a platen unit to convey a recording medium supplied by a feeding unit to the downstream side by rotating a belt with the width larger than the recording medium; an up-and-down mechanism to move up and down a platen unit; an image recording unit which is placed opposite to a platen unit, and provided with a line head for recording an image by ejecting ink from nozzles to a recording medium conveyed; a maintenance mechanism to perform maintenance for nozzles of a line head; a maintenance moving mechanism to move a maintenance mechanism to a position opposite to a line head; a double-side reversing mechanism which reverses and re-feeds a recording medium in order to record on both sides of a recording medium; and a discharge unit to discharge the recording medium recorded by the image recording unit, with the last recorded side turned up, wherein when recording an image, the maintenance mechanism is placed on the opposite side of the image recording unit through a recording medium conveying route in the conveying mechanism, at least one of the upstream side and downstream side of a recording medium conveying direction in the platen unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing the configuration of an image recording apparatus according to a first embodiment of the invention;

FIG. 2 is a perspective view schematically showing the part around a platen unit and up-and-down mechanism provided in a conveying mechanism;

FIG. 3 is a perspective view schematically showing a conveying force selectable part;

FIG. 4 is a perspective view schematically showing the part around a support member;

FIG. 5 is a perspective view schematically showing a sheet member;

FIG. 6 is a perspective view schematically showing the arrangement of a maintenance mechanism and maintenance moving mechanism;

FIG. 7A is a view showing the arrangement of a support member, a driven roller, a drive roller, and a maintenance mechanism;

FIG. 7B is a view showing the arrangement of a support member, a driven roller, a drive roller, and a maintenance mechanism;

FIG. 7C is a view showing the arrangement of a support member, a driven roller, a drive roller, and a maintenance mechanism;

FIG. 8A is a view showing the arrangements of a maintenance mechanism and up-and-down mechanism at the time of maintenance of a nozzle;

FIG. 8B is a view showing the arrangements of a maintenance mechanism and up-and-down mechanism at the time of maintenance of a nozzle;

FIG. 8C is a view showing the arrangements of a maintenance mechanism and up-and-down mechanism at the time of maintenance of a nozzle;

FIG. 8D is a view showing the arrangements of a maintenance mechanism and up-and-down mechanism at the time of maintenance of a nozzle;

FIG. 9A is a side view schematically showing a maintenance mechanism coming close to a nozzle;

FIG. 9B is a side view schematically showing a maintenance mechanism capping a nozzle;

FIG. 10 is a schematic diagram showing the configuration of an image recording apparatus in a first modification of a first embodiment;

FIG. 11 is a schematic diagram showing the configuration of an image recording apparatus in a second modification of a first embodiment;

FIG. 12 is a schematic diagram showing the configuration of an image recording apparatus in a third modification of a first embodiment;

FIG. 13A is a view of a modification of the arrangement of a support member, a driven roller, a drive roller, and a maintenance mechanism;

FIG. 13B is a view of a modification of the arrangement of a support member, a driven roller, a drive roller, and a maintenance mechanism;

FIG. 13C is a view of a modification of the arrangement of a support member, a driven roller, a drive roller, and a maintenance mechanism;

FIG. 13D is a view of a modification of the arrangement of a support member, a driven roller, a drive roller, and a maintenance mechanism;

FIG. 14 is a view showing the configuration of a conventional ink-jet recording apparatus;

FIG. 15A is a view showing the configuration of a conventional ink-jet recording apparatus; and

FIG. 15B is a view showing the configuration of a conventional ink-jet recording apparatus.

### DETAILED DESCRIPTION OF THE INVENTION

Embodiments of the present invention will be explained hereinafter with reference to the accompanying drawings.

In the following explanation and drawings, a recording medium conveying direction is assumed an X-axis direction or a sub-scanning direction, and a direction perpendicular to the conveying direction is assumed a Y-axis direction, a main scanning direction or a recording medium width direction. A direction perpendicular to the X-axis direction and Y-axis direction is assumed a Z-axis direction or a vertical direction.

A route of conveying a recording medium is called a conveying route.

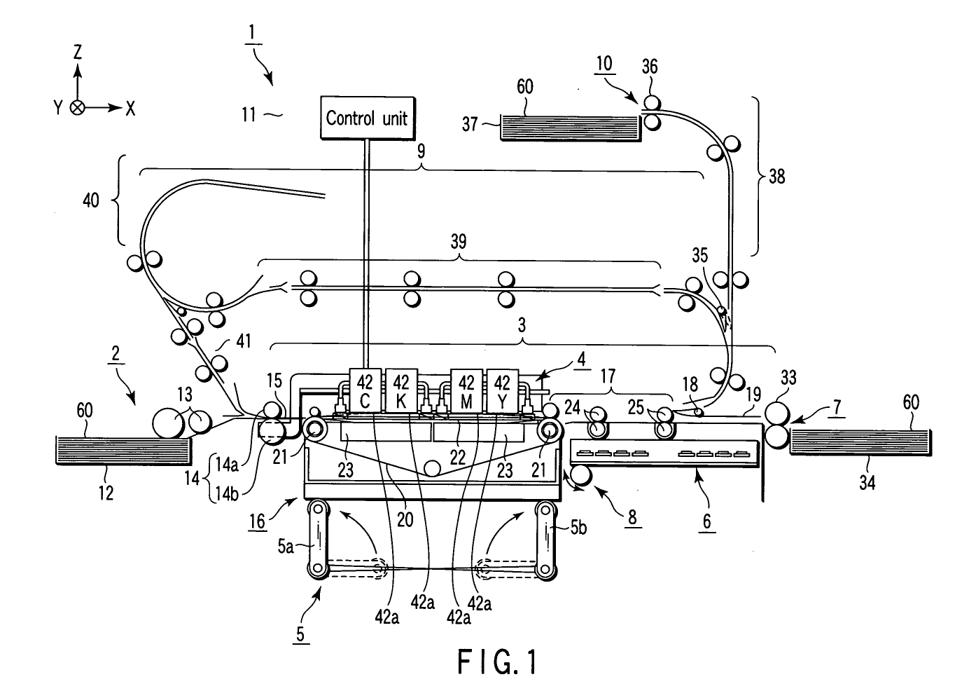

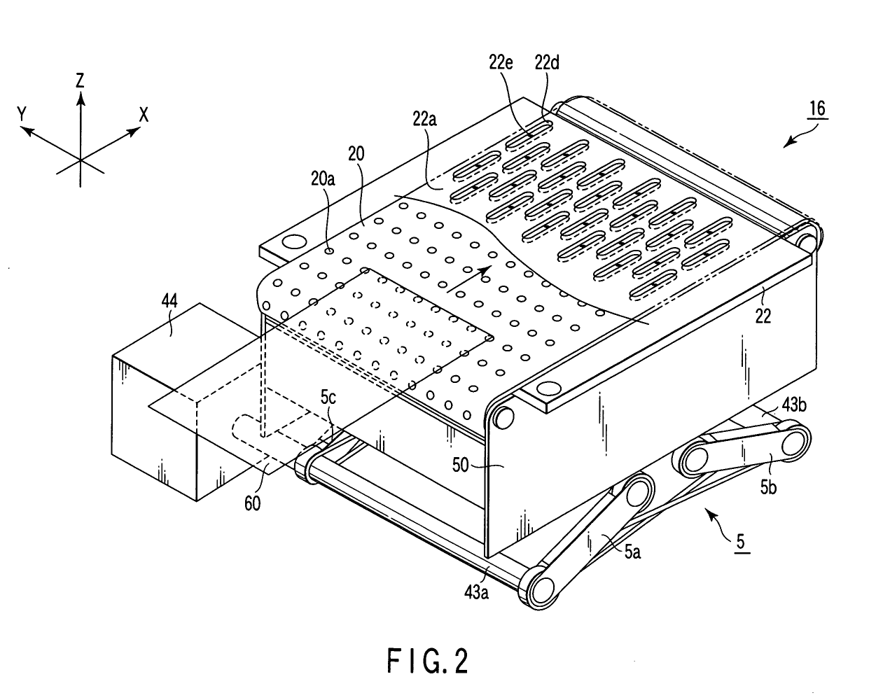

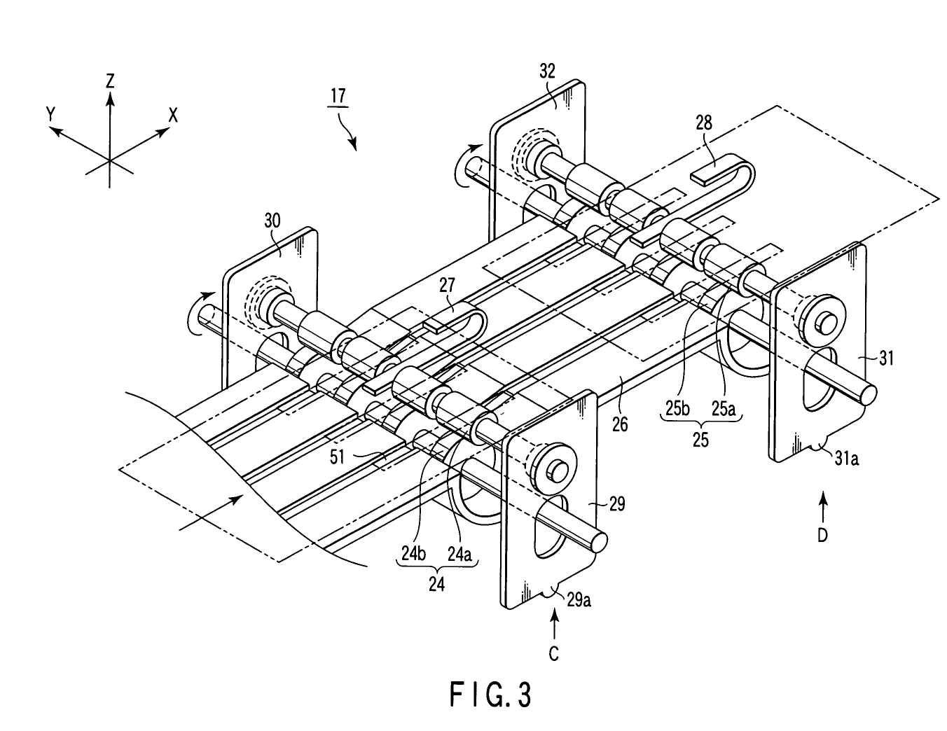

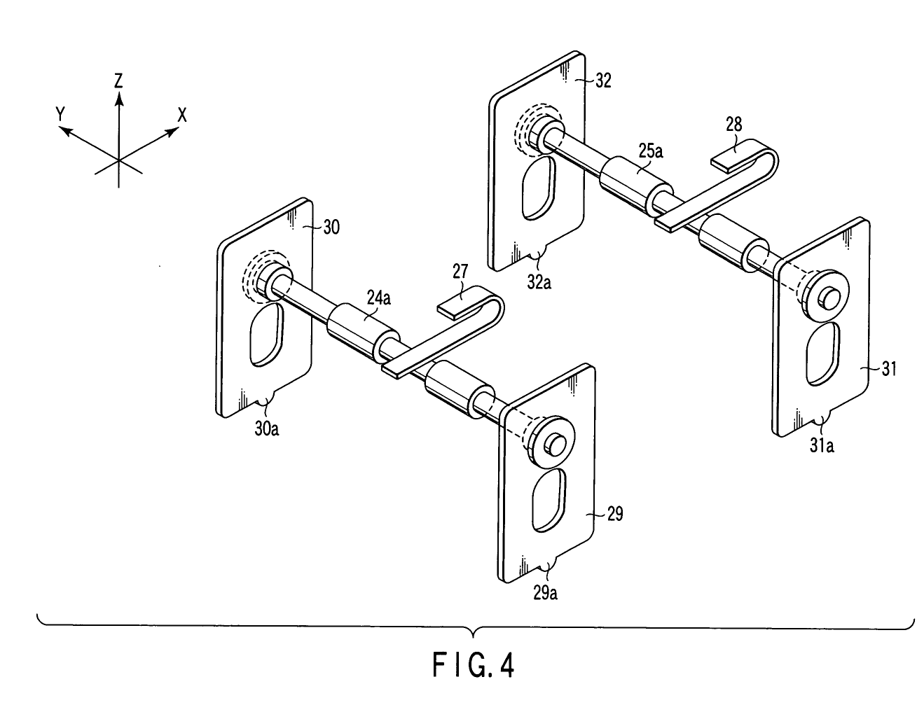

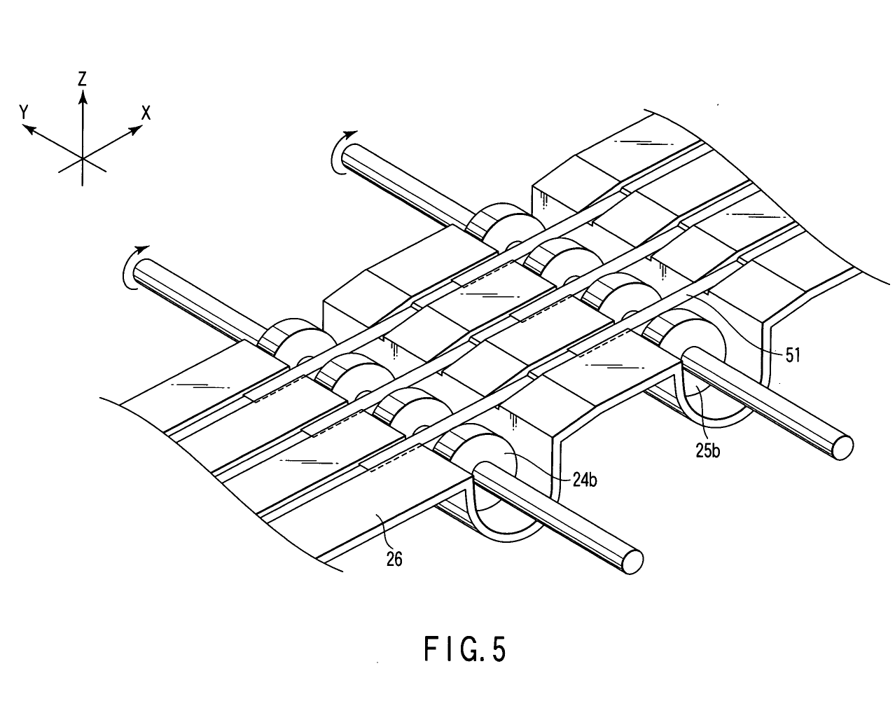

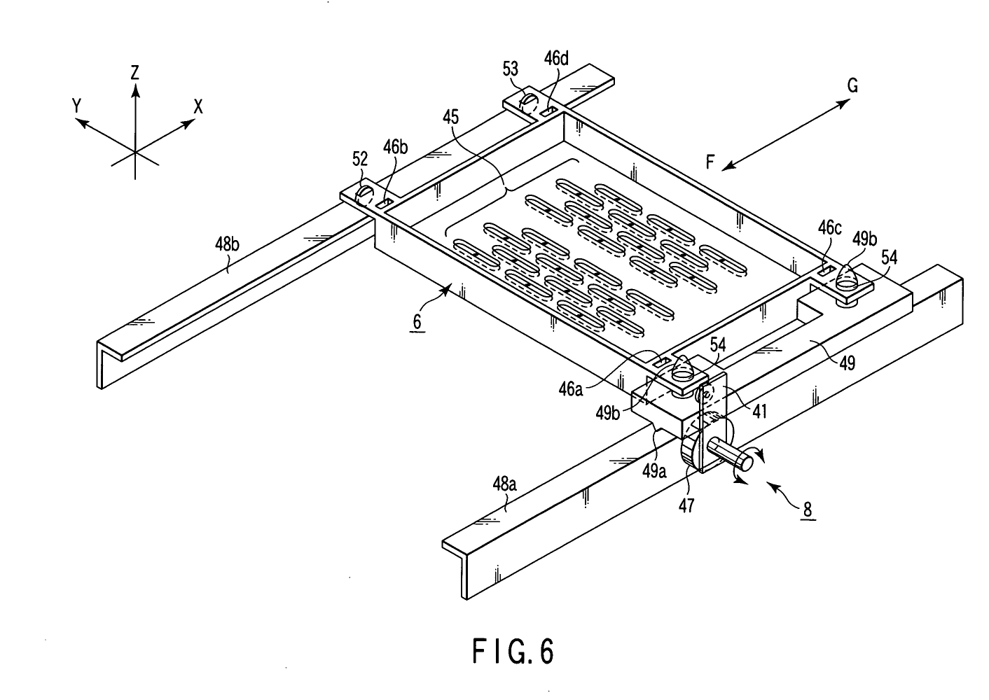

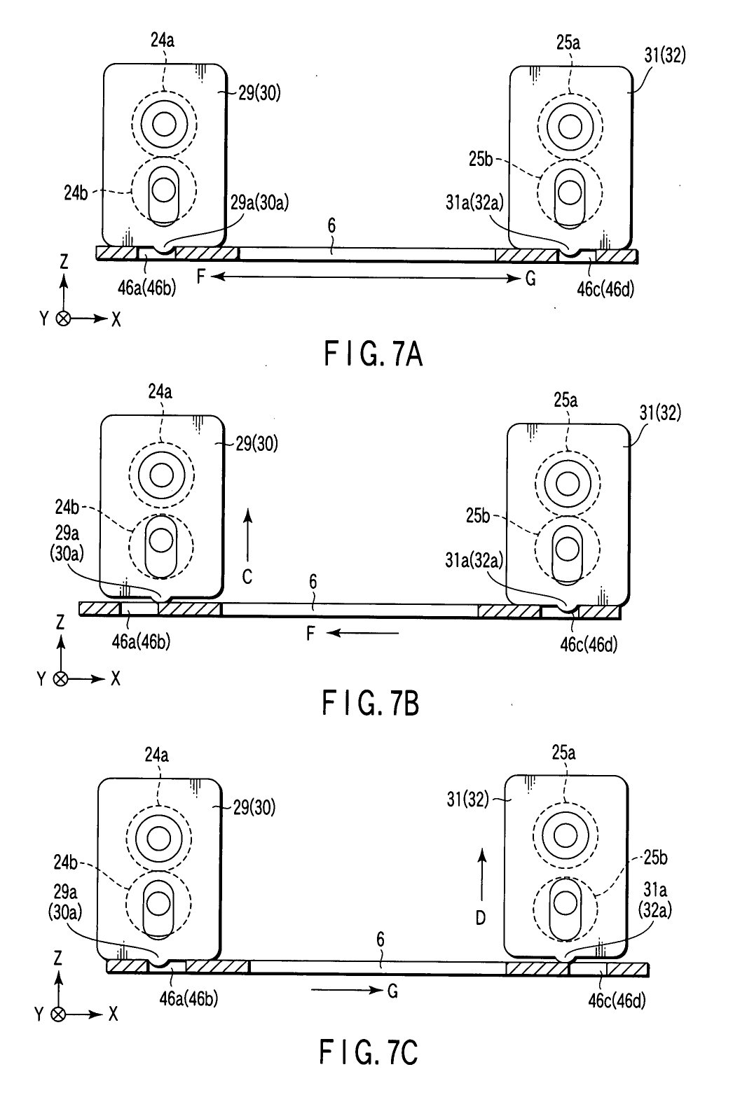

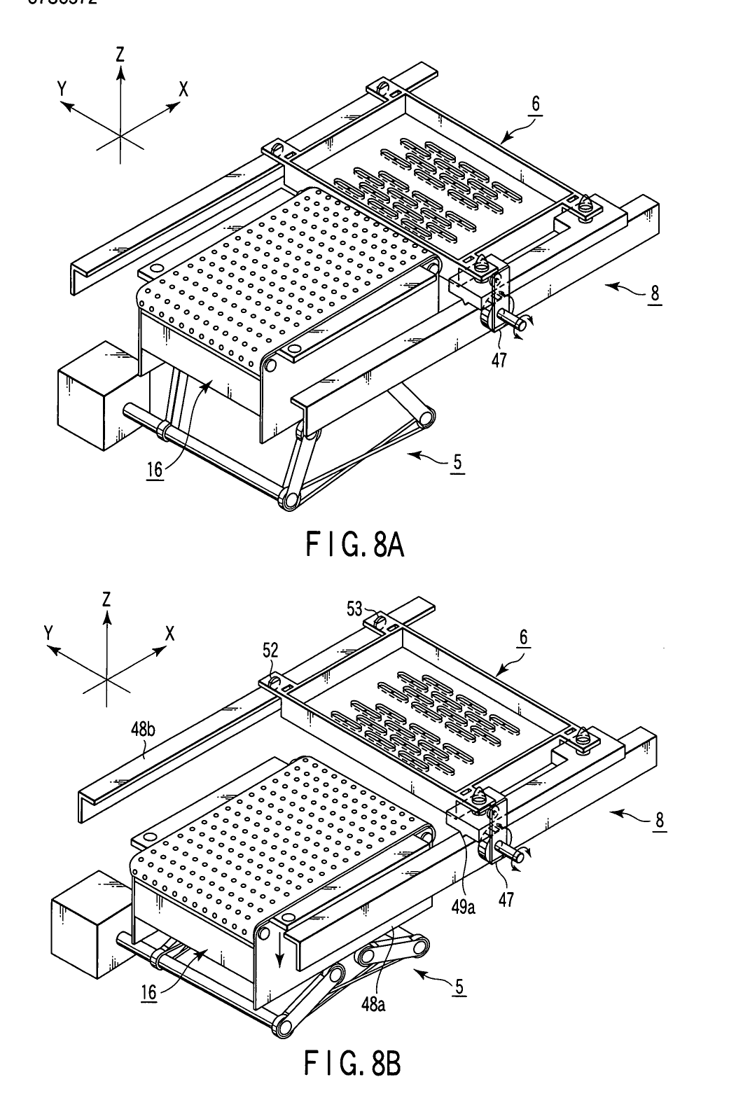

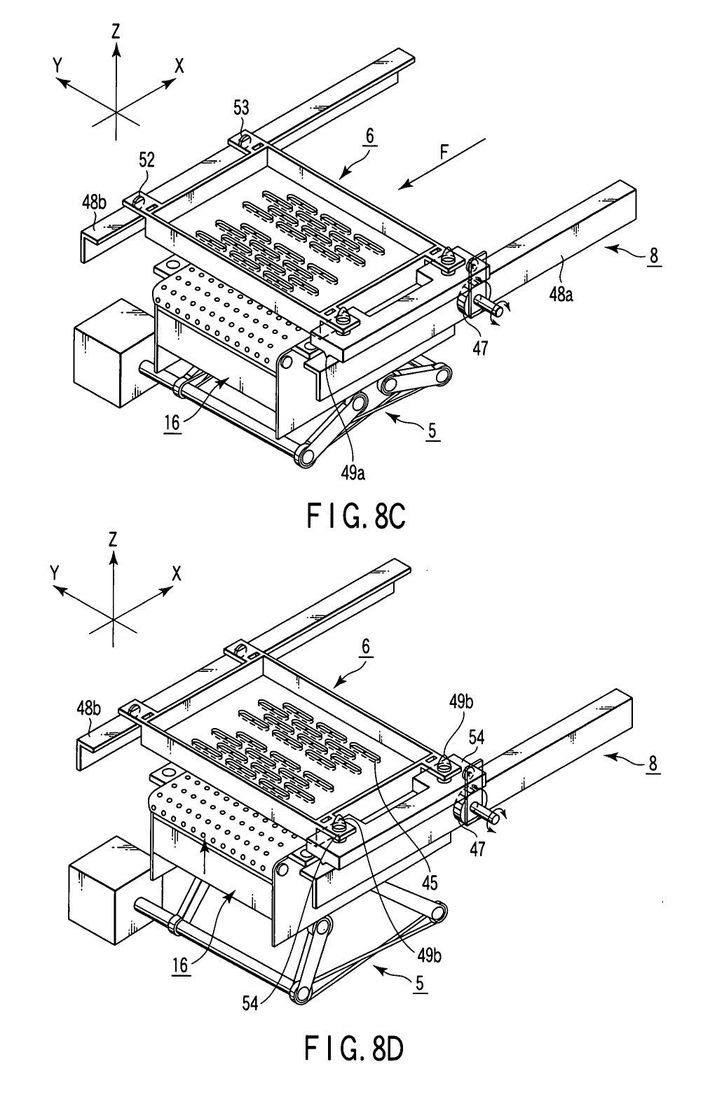

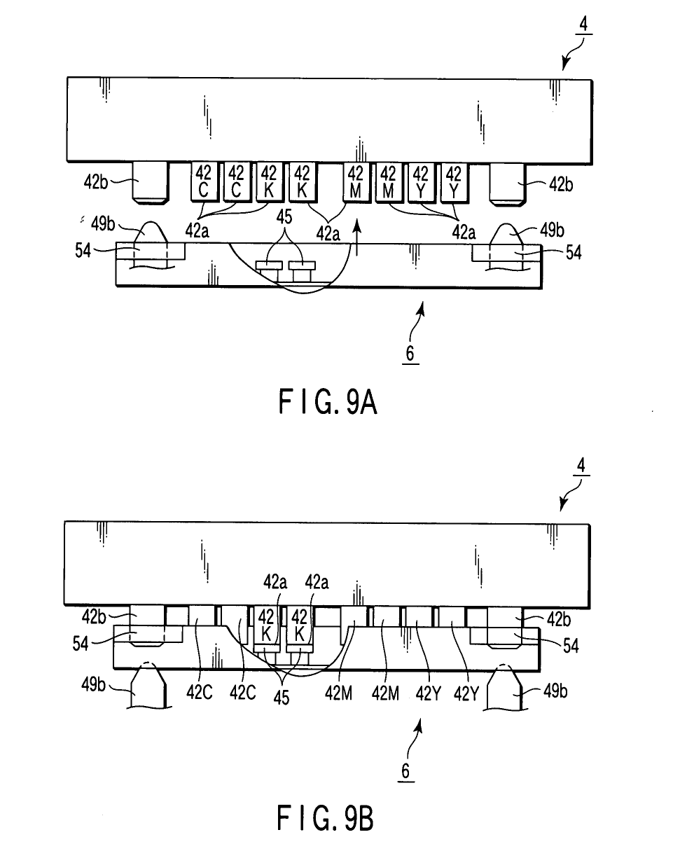

A first embodiment will be explained with reference to FIG. 1-FIG. 9. FIG. 1 is a schematic diagram showing the configuration of an image recording apparatus according to a first embodiment. FIG. 2 is a perspective view schematically showing the part around a platen unit and up-and-down mechanism provided in a conveying mechanism. FIG. 3 is a perspective view schematically showing a conveying force selectable part. FIG. 4 is a perspective view schematically showing the part around a support member. FIG. 5 is a perspective view schematically showing a sheet member. FIG. 6 is a perspective view schematically showing the arrangement of a maintenance mechanism and a maintenance moving mechanism. FIGS. 7A, 7B and 7C are views showing the arrangements of a support member, a driven roller, a drive roller, and a maintenance mechanism in the first embodiment. FIGS. 8A, 8B, 8C and 8D are views showing the arrangements of a maintenance mechanism and up-and-down mechanism at the time of maintenance of a nozzle. FIG. 9A is a side view schematically showing a maintenance mechanism coming close to a nozzle. FIG. 9B is a side view schematically showing a maintenance mechanism capping a nozzle.

In FIG. 1, an image recording apparatus 1 according to a first embodiment comprises a feeding unit 2, a conveying mechanism 3, an image recording unit 4, an up-and-down mechanism 5, a maintenance mechanism 6, a first discharge unit 7, a maintenance moving mechanism 8, a double-side reversing mechanism 9, a second discharge unit 10, an ink supply unit (not shown), and a control unit 11, which are mounted as main components on a not-shown apparatus frame.

The feeding unit 2 will be first explained. The feeding unit 2 has a recording medium tray 12, and a pickup roller 13.

The recording medium tray 12 is a recording medium storing capable of storing recording medium 60 of different kinds and size. The recording medium tray 12 of this embodiment contains two or more one size cut-sheet recording medium 60.

The pickup roller 13 is a recording medium takeout part to take out (feed) the recording medium 60 stored in the recording medium tray 12 one by one. The pickup roller 13 is rotatably supported by a not-shown apparatus frame.

Next, explanation will be given on the conveying mechanism 3 provided in the downstream side of the feeding unit 2. The conveying mechanism 3 has a pair of registration rollers 14, a feed guide 15, a platen unit 16, a conveying force selectable part 17, a first conveying route switching gate 18, and a discharge guide 19.

The pair of registration roller 14 provided in the downstream of the pickup roller 13 is a conveying direction adjusting part to correct a skew movement by positioning the recording medium 60 taken out by the pickup roller 13 in the conveying direction.

The pair of registration rollers 14 has a driven roller 14a and a drive roller 14b. The driven roller 14a is rotatably supported by a lever operable by the user. The drive roller 14b is rotatably supported by the image recording unit 4. The drive roller 14b is provided under the driven roller 14a.

The pair of registration rollers 14 is provided at a position within the dimension (the dimensions in the conveying direction) of the recording medium 60 from the pickup roller 13 in the X-axis direction, in order to securely convey the recording medium 60 taken out by the pickup roller 13.

In the above configuration, when the front end of the recording medium 60 during conveying touches on the pair of registration rollers 14, the rear end is nipped by the pickup roller 13. Therefore, conveyance of the recording medium 60 is assisted by the pickup roller 13 for at least a period that the pair of registration rollers 14 nips the front end of the recording medium 60.

The pickup roller 13 and registration rollers 14 are connected to a not-shown common driving force transmission system, and supplied with a driving force from the driving force transmission system. The driving force transmission system is connected to a not-shown motor, and driven following the motor operation. The motor is provided with an encoder to detect the number of revolutions. The encoder and motor are connected to the control unit 11. The control unit 11 controls operation of the motor and driving force transmission system, based on the encoder output (the number of revolutions, etc.).

The pickup roller 13 and registration rollers 14 are configured to freely release the connection to the driving force transmission system by a clutch. Further, each clutch is connected to the control unit 11, and turned on/off by the control unit 11.

The feed guide 15 is provided to lead the recording medium 60 conveyed by the pickup roller 13 to the registration rollers 14, and to lead the recording medium 60 conveyed by the registration rollers 14 to the platen unit 16.

The platen unit 16 has a platen belt 20 to convey the recording medium 60 supplied from the feeding unit 2 to the downstream, platen belt rollers 21, a platen frame 22, a platen suction unit 23, and a plate support frame 50, as shown in FIG. 1 and FIG. 2. The platen unit 16 is a conveying unit to convey the recording medium 60 supplied from the feeding unit 2 to the downstream.

The platen belt 20 is hung between the platen belt rollers 21, and formed like a belt-like endless ring. The width of the platen belt 20 is larger than the maximum width of the recording medium 60 supplied from the feeding unit 2 and used for recording an image. The platen belt 20 is evenly provided with suction holes 20a consisting of small holes all over the belt. The platen unit 16 conveys the recording medium 60 to the downstream by rotating the platen belt 20.

The platen belt rollers 21 are rotatably supported by the platen support frame 50, so that the surface of the platen belt 20 opposite to the image recording unit 4 becomes flat (parallel) to the nozzle surface of the line head 42. At least one of the platen belt rollers 21 is connected to a drive motor to rotate the platen belt roller 21. When the platen belt rollers 21 are rotates, the platen belt 20 is rotated and the recording medium 60 is conveyed. The platen belt 20 and platen belt rollers 21 cooperate to convey the recording medium 60 to the downstream, forming a belt conveyer. The platen belt 20 and platen belt rollers 21 set the conveying direction of the recording medium 60 at the time of recording. Namely, the platen belt 20 and platen belt rollers 21 are assembled to convey the recording medium 60 in the X-axis direction in this embodiment.

The platen frame 22 is supported by the plate support frame 50. The platen frame 22 has a platen frame surface 22a. The platen frame surface 22a supports the platen belt 20 so that the platen belt 20 hung between the platen belt rollers 21 becomes flat, in the area opposite to the image recording unit 4. On the platen frame surface 22a, grooves 22d are formed hanging in the X-axis direction. At substantially the center of each groove 22d, a hole 22e is formed penetrating the platen suction unit 23.

The platen suction unit 23 is provided under the platen frame 22. The platen suction unit 23 is a negative pressure generator to generate a negative pressure in the platen frame surface 22a. The platen suction unit 23 draws air through the suction holes 20a formed on the platen belt 20 and the hole 22e platen frame surface 22a, and draws (absorbs) the conveyed recording medium 60 onto the platen belt 20.

The conveying force selectable part 17 provided in the downstream of the plate unit 16 has pairs of medium conveying rollers 24 and 25 and a conveying guide 26, as shown in FIG. 3.

The medium conveying rollers 24 and 25 convey the recording medium 60 recorded by the image recording unit 4 to the downstream. The medium conveying rollers 24 have a driven roller 24a, and a drive roller 24b provided under the driven roller 24a. The medium conveying rollers 25 have a driven roller 25a, and a drive roller 25b provided under the driven roller 25a.

The driven roller 24a is pressed to the drive roller 24b by a nip spring 27 for nipping. The driven roller 25a is pressed to the drive roller 25b by a nip spring 28 for nipping.

As shown in FIG. 4, the driven roller 24a is supported by support members 29 and 30. The driven roller 25a is supported by support members 31 and 32. The support members 29, 30, 31 and 32 are provided with projections 29a, 30a, 31a and 32a, respectively. These projections 29a, 30a, 31a and 32a move up/down the support members 29, 30, 31 and 32 by movement of the maintenance mechanism 6 described later. Namely, the driven rollers 24a and 25a are raised in the directions of the arrows C and D for example, as shown in FIG. 3. The driven rollers 24a and 25a can be moved up/down by the support members 29, 30, 31 and 32. When the driven rollers 24a and 25a are moved up/down, the nip to the drive roller 24b and 25b by the driven roller 24a and 25a is released (the details will be explained in FIG. 7).

The conveying guide 26 is provided above the maintenance mechanism 6, and used as a part of a conveying route to convey the recording medium 60 to the downstream side, as shown in FIG. 5. The conveying guide 26 is an outer jacket functioning also as a cover, which covers the maintenance mechanism 6 described later to prevent intrusion of dust into the maintenance mechanism 6, when recording an image. If the conveying guide 26 is formed by molding, the part to fit the drive rollers 24b and 25b becomes wide, and the recording medium 60 will go into there. Therefore, in this embodiment, the sheet members 51 are fit in the drive roller 24b and 25b, whereby the sheet members 51 prevent the recording medium 60 from going into the groove.

In the downstream side of the conveying force selectable part 17, a first conveying route switching gate 18 and a discharge guide 19 are provided. The first conveying route switching gate 18 selects and changes a recording medium conveying destination to a double-side reversing mechanism 9 provided above the image recording apparatus 1 described later, or the discharge guide 19. The first conveying route switching gate 18 is placed above the maintenance mechanism 6. The discharge guide 19 is provided to lead the recorded recording medium 60 to the first discharge unit 7.

Next, explanation will be given on the image recording unit 4 provided above and opposite to the platen unit 16. The image recording unit 4 is an ink ejection unit to eject ink to the recording medium 60 conveyed by the platen unit 16.

The image recording unit 4 has line heads 42, a maintenance positioning pin 42b, a not-shown head holding frame, and a head cooler. The line heads 42 form a main part of the image recording unit 4 for recording an image. The image recording unit 4 has line heads (42C, 42K, 42M and 42Y) for ejecting cyan (C), black (K), magenta (M) and yellow (Y) color ink. Each line head 42 (42C, 42K, 42M and 42Y) consists of one or more recording heads in the length larger than the maximum width of the recording medium 60 used for recording an image, like the width of the platen belt 20. In this embodiment, six recording heads constitute one line head.

In each line head 42, a nozzle 42a is formed on the surface opposite to the recording medium 60 to be conveyed. The nozzles 42a form a nozzle line along the Y-axis direction.

The nozzle 42a ejects the ink supplied from ink supply in the gravity direction (vertically downward).

The not-shown head holding frame holds the line head 42 by suspending. Therefore, the line head 42 is fixed and not moved up and down.

The not-shown head cooler prevents spread of ink bubbles upon ejection of ink, by cooling the line head 42 by water or air.

Now, explanation will be given on the up-and-down mechanism 5 provided under the platen unit 16. The up-and-down mechanism 5 has an up/down arms (5a, 5b, 5c and 5d) to move up/down the platen unit 16, as shown in FIG. 2. The up/down arms 5a and 5c are held by the arm shaft 43a rotatably held by a not-shown apparatus main body frame. The up/down arms 5b and 5d are held by the arm shaft 43b rotatably held by a not-shown apparatus main body frame.

The arm shaft 43a is connected to an up-and-down drive 44. As the arm shaft 43a and arm shaft 43b are connected by a not-shown drive transmission system, when the up-and-down drive 44 is driven, the arm shaft 43a is rotated, and the arm shaft 43b is rotated in the opposite direction reverse to the rotation of the arm shaft 43a, interlocking with the rotation of the arm shaft 43a.

When the arm shafts 43a and 43b are rotated, four up-down arms (5a, 5b, 5c and 5d) are moved rotationally from a horizontal position indicated by a broken line to a vertical position indicated by a solid line, as shown in FIG. 1. Four up/down arms (5a, 5b, 5c and 5d) move up/down the platen unit 16 by sliding on and touching on the bottom of the platen unit 16.

Next, the maintenance mechanism 6 will be explained. The maintenance mechanism 6 performs maintenance for the nozzle 42a. When recording an image, as shown in FIG. 1, the maintenance mechanism 6 is placed on the opposite side of the image recording unit 4, in the downstream of the recording medium 60 conveying direction in the platen unit 16, through the recording medium 60 conveying route in the conveying mechanism 3. The maintenance mechanism 6 is placed under the first conveying route switching gate 18. As shown in FIG. 6, the maintenance mechanism 6 has a cap unit 45, a slit holes 46a, 46b, 46c and 46d, rollers 52 and 53, and holes 54.

The cap unit 45 is provided corresponding to each line head 42. The cap unit 45 caps the nozzle 42a of each line head 42, and prevents the nozzle 42a from drying (performs maintenance).

The slit holes 46a, 46b, 46c and 46d are provided corresponding to the projections 29a, 30a, 31a and 32a in the conveying force selectable part 17.

The rollers 52 and 53 are provided in the proximity of the slit holes 46b and 46d. The rollers 52 and 53 are provided to move the maintenance mechanism 6 in the X-axis direction (the arrow F or G) on the guide member 48b described later. The holes 54 are provided in the proximity of the slit holes 46a and 46c.

Next, explanation will be given on the maintenance moving mechanism 8, which moves the maintenance mechanism 6 in the X-axis direction (the arrow F or G). When the maintenance mechanism 6 performs maintenance for the nozzle 42a, the maintenance moving mechanism 8 moves the maintenance mechanism 6 to a position opposite to the nozzle 42a of the line head 42. The maintenance moving mechanism 8 has a gear 47 rotatably supported by the main body frame, a not-shown drive motor to drive the gear 47, guide members 48a and 48b to mount the maintenance mechanism 6, and a rack 49 to move on the guide member 48a by the gear 47.

The rack 49 has a pointed portion 49a to contact the guide member 48a, and two projections 49b to be inserted into the holes 54.

The maintenance mechanism 6 is mounted on the guide members 48a and 48b. The mounted maintenance mechanism 6 is prevented from deviating from the guide members 48a and 48b in the X-axis and Y-axis directions, by the projection 49b inserted into the holes 54. As the rack 49 is provided with the pointed portion 49a, when the rack 49 is moved on the guide member 48a, a friction between the rack 49 and guide member 48a can be reduced.

The slit holes 46a, 46b, 46c and 46d correspond to the projections 29a, 30a, 31a and 32a, as described above. When the maintenance mechanism 6 is moved by the maintenance moving mechanism 8, it is possible to select the state that the projections 29a, 30a, 31a and 32a are inserted or not inserted into the slit holes 46a, 46b, 46c and 46d. Therefore, the driven rollers 24a and 25a in the conveying force selectable part 17 can select the presence or absence of a nip pressure for the drive rollers 24b and 25b.

FIG. 7A shows the state that the projections 29a, 30a, 31a and 32a are inserted into the slit holes 46a, 46b, 46c and 46d, and the driven rollers 24a and 25a apply a nip pressure to the drive rollers 24b and 25b.

FIG. 7B shows the state that the support members 29 and 30 are moved up. Namely, the maintenance mechanism 6 is moved in the direction F, the projections 29a and 30a come out of the slit holes 46a and 46b, and the support members 29 and 30 are moved up in the direction C. Namely, the driven roller 24a does not apply a nip pressure to the drive roller 24b. The projections 31a and 32a are inserted into the slit hole 46c and 46d, and the driven roller 25a applies a nip pressure to the drive roller 25b.

FIG. 7C shows the state that the support members 31 and 32 are moved up. Namely, the maintenance mechanism 6 is moved in the direction G, and the projections 31a and 32a come out of the slit holes 46c and 46d, and the support members 31 and 32 are moved up in the direction D. The driven roller 25a does not apply a nip pressure to the drive roller 25b. As the projections 29a and 30a are inserted into the slit holes 46a and 46b, the driven roller 24a applies a nip pressure to the drive roller 24b. For example, the front end of the recording medium 60 recorded by the image recording unit 4 is conveyed by the medium conveying rollers 24 and 25 of the conveying force selectable part 17. In this time, if the rear end of the recording medium 60 has been recorded by the line head 42 of the most downstream side in the image recording unit 4, ink is deviated from normal ejection by the influence of the nip force of the medium conveying rollers 24 and 25, causing deterioration of image quality. Therefore, at least the medium conveying rollers 24 must be placed at the position separated from the line head 42 of the most downstream side in the image recording unit 4 by the dimension of the recording medium 60 (the measure in the conveying direction). However, the conveying recording medium 60 is generally not one kind. Therefore, it is actually difficult to place the medium conveying rollers 24 at the position separated by the dimension of the recording medium 60 (the dimension in the conveying direction). In this embodiment, the nip force of the medium conveying rollers 24 and 25 can be selectively released. Therefore, compact and high-quality image recording is possible free from the influence of the nip force by the medium conveying rollers 24 and 25, regardless of the kinds of the recording medium 60 to be conveyed.

Explanation will now be given on the first discharge unit 7 provided in the downstream of the discharge guide 19. The first discharge unit 7 is a discharge part to discharge the recording medium 60 recorded in the image recording unit 4. The first discharge unit 7 has a pair of conveying rollers 33 to discharge (convey) the recorded recording medium 60, and a first discharge tray 34 to store the recorded recording medium 60. The first discharge unit 7 discharges the recording medium 60 to the first discharge tray 34 with the last recorded side turned up, in the recording medium 60 recorded by the image recording unit 4. Namely, when an image is recorded on one side, an image is recorded on the front side of the recording medium 60, for example, and the recording medium 60 is discharged to the first discharge tray 34 with the recorded front side turned up. When an image is recorded on both sides, an image is recorded sequentially on the front side and back side of the recording medium 60, and the recording medium 60 is discharged to the first discharge tray 34 with the back side turned up.

Explanation will now be given on the double-side reversing mechanism 9 provided in the upper part of the image recording apparatus 1. The double-side reversing mechanism 9 has a second conveying route switching gate 35, a reverse conveying route 39, a switchback unit 40, and a refeed unit 41.

The second conveying route switching gate 35 selects and changes the destination of the recording medium 60 conveyed to the upper part of the image recording apparatus 1 through the first conveying route switching gate 18, to one of the reverse conveying route 39 and the route 38 in the second discharge unit 10.

The reverse conveying route 39 conveys the recording medium 60 to the switchback unit 40. The switchback unit 40 reverses the recording medium 60 so that the non-recorded side is faced to the image recording unit 4, in order to record an image on both sides of the recording medium 60. The refeed unit 41 conveys the reversed recording medium 60 again to the registration rollers 14, and re-feeds the recording medium 60 to the image recording unit 4. The image recording unit 4 records an image by ejecting ink. Then, the recording medium 60 is recorded on both sides.

The second discharge unit 10 will be explained. The second discharge unit 10 is provided in the upper part of the image recording apparatus 1, and has the route 38, a pair of conveying rollers 36 and a second discharge tray 37. The conveying rollers 36 discharges the recording medium 60 conveyed on the route 38 to the discharge tray 37. The second discharge tray 37 stores the discharged recording medium 60. The second discharge unit 10 discharges the recording medium 60 to the second discharge tray 37 with the last recorded side turned downward, in the recording medium 60 recorded by the image recording unit 4.

The control unit 11 will now be explained. The control unit 11 comprises a computer including a not-shown CPU, a timer, a ROM, a RAM and an input unit. The control unit 11 is connected to the feeding unit 2, conveying mechanism 3, image recording unit 4, up-and-down mechanism 5, maintenance mechanism 6, first discharge unit 7, maintenance moving mechanism 8, double-side reversing mechanism 9, second discharge unit 10, and not-shown ink supply unit. The control unit 11 controls the operation of these units.

Next, explanation will be given on the operation of the whole image recording apparatus 1.

In this embodiment, the control unit 11 first rotates the pickup roller 13. The pickup roller 13 picks up the recording medium 60 one by one from the recording medium tray 12, and feeds the recording medium 60 to the registration rollers 14 along the X-axis direction.

When the recording medium 60 is fed, the control unit 11 obtains the information on the recording medium 60 stored the ROM, for example, the coefficient of friction of the surface. In this time, according to the coefficient of friction of the surface of the recording medium 60, a timer difference occurs when the pickup roller 13 picks up the recording medium 60. Therefore, the control unit 11 sets the pickup roller 13 driving time according to the coefficient of friction of the recording medium 60.

The recording medium 60 picked up from the recording medium tray 12 is conveyed by the pickup roller 13 along the feed guide 15, and touched on the registration rollers 14. When the recording medium 60 is touched on the registration rollers 14, the forward end of the recording medium 60 to the registration rollers 14 may skew (zigzag). Therefore, after the recording medium 60 is touched on the registration rollers 14, the control unit 11 drives the pickup roller 13 for a desired time. Then, the recording medium 60 makes a certain loop for the not-driven registration rollers 14. Further, all area of the front end of the recording medium 60 pressed by the pickup roller 13 touches on the all lengths of the registration rollers 14. Then, the skew of the recording medium 60 is corrected, and the longitudinal direction of the recording medium 60 becomes parallel to the X-axis direction.

Then, the control unit 11 drives the registration rollers 14, and the recording medium 60 is conveyed in the downstream direction. The control unit 11 refers to the information on the recording medium 60 when driving the registration rollers 14. If the coefficient of friction of the recording medium 60 is found to be lower than that of an ordinary paper sheet as a result of the reference, the control unit 11 drives also the pickup roller 13. Then, the recording medium 60 is securely nipped to the registration rollers 14, and securely conveyed even if the coefficient of friction is low. Namely, the pickup roller 13 assists the registration rollers 14 in conveying the recording medium 60.

After passing through the registration rollers 14, the recording medium 60 is passed through the feed guide 15, and conveyed to the platen unit 16. Before the recording medium 60 is conveyed from the feeding unit 2 to the conveying mechanism 3, the control unit 11 gives a drive instruction to the platen suction unit 23 and not-shown belt roller drive motor, and drives the platen belt 20. The recording medium 60 is conveyed from the feeding unit 2 to the platen unit 16 of the conveying mechanism 3, held tightly by the platen belt 20, and conveyed along the X-axis direction at a desired speed.

As explained above, the skew of the recording medium 60 is corrected by the registration rollers 14. Then, before the recording medium 60 is conveyed to the position opposite to the line head 41, the positions of both side ends of the recording medium 60 are read by a not-shown image width detection unit. The control unit 11 sets an image recording range for the recording medium 60 from the read positions of both side ends. Therefore, the control unit 11 can prevent recording an image beyond the width of the recording medium 60. When the front end of the recording medium 60 is conveyed to the position opposite to the line head 42, the control unit 11 gives an image recording instruction to the image recording unit 4. The line heads 42C, 42K, 42M and 42Y eject ink from the nozzle 42a to the recording medium 60. Ink is ejected from every line head 42. As the line head 42 is hung on all over the width of the recording medium 60, the line head 42 records an image all over the width of the recording medium 60 on the recording medium 60 by ejecting ink only once.

As the image recording advances, the platen unit 16 conveys the recording medium 60 in the X-axis direction. Therefore, an image is sequentially recorded in the longitudinal direction of the recording medium 60. In this time, as air is drawn from the platen belt 20 through many suction holes 20a provided on the platen belt 20 and the holes 22e provided on the platen frame 22, the recording medium 60 is conveyed in being stuck to the platen belt 20.

The front end of the recorded recording medium 60 is conveyed to the medium conveying rollers 24 and 25. In this time, the medium conveying rollers 24 and 25 are configured to select to having a nip pressure and not having a nip pressure, as explained before. Namely, the control unit 11 obtains the information on the conveyed recording medium 60, for example, the size, and selects to having or not having a nip pressure of the medium conveying rollers 24 and 25 according to the obtained information.

After passing through the conveying force selectable part 17, the recording medium 60 is conveyed to the first discharge unit 7 or the double-side reversing mechanism 9, as described above.

Next, the maintenance operation by the maintenance mechanism will be explained with reference to FIGS. 8A, 8B, 8C, 8D and FIGS. 9A and 9B.

In this embodiment, the maintenance operation includes capping and suction. In the capping operation, the cap unit 45 provided in the maintenance mechanism 6 caps the nozzle 42a provided in the line head 42, shuts off the ink adhering to the nozzle 42a from the outside air, and prevents the ink from solidifying. In the suction operation, the air in the cap is drawn by a not-shown suction pump in the state shut off from the outside air, and the ink is drawn out from the head.

When performing the maintenance operation to stabilize the image recording, the up-and-down mechanism 5, maintenance mechanism 6, maintenance moving mechanism 8 and plate unit 16 are placed in the state shown in FIG. 8A. At the opposite position above the platen unit 16 in FIGS. 8A, 8B, 8C and 8D, a not-shown line head 42 is placed.

As shown in FIG. 8B, the platen unit 16 is moved down by the up-and-down mechanism 5.

As shown in FIG. 8C, the maintenance mechanism 6 is moved in the direction of the arrow F by the maintenance moving mechanism 8. When the platen unit 16 is moved down by the up-and-down mechanism 5, the maintenance moving mechanism 8 moves the maintenance mechanism 6 to the space formed by moving down the platen unit 16 by the up-and-down mechanism 5. The maintenance moving mechanism 8 moves the maintenance mechanism 6 to the position opposite to the nozzle 42a. Concretely, the maintenance mechanism 6 is moved in the direction of the arrow F by that the rollers 52 and 53 and pointed portion 49a are moved on the guide members 48a and 49b by the gear 47. Therefore, the maintenance mechanism 6 is placed opposite to the line head 42. The nozzle 42a is faced to the cap unit 45, and the maintenance position pin 42b is faced to the projection 49b and hole 54.

Then, as shown in FIG. 8D, the up-and-down mechanism 5 moves up the maintenance mechanism 6 through the platen unit 16, so that a desired space is taken between the maintenance mechanism 6 and line head 42.

Then, as shown in FIG. 9A, a relative interval between the maintenance mechanism 6 and line head 42 becomes short. The cap unit 45 comes close to the nozzle 42a, and the projection 49b provided in the rack 49 gradually comes out of the hole 54 of the maintenance mechanism 6. When the maintenance mechanism 6 is moved up by the up-and-down mechanism 5, the projection 49b comes out of the hole 54, and the maintenance positioning pin 42b provided in the image recording unit 4 is inserted into the hole 54. The positions of the maintenance mechanism 6 in the X-direction and Y-direction with respect to the image recording unit 4 at the time of maintenance are determined in this way. After the maintenance positioning pin 42b is inserted into the hole 54, if the maintenance mechanism 6 is moved up further by the up-and-down mechanism 5, the cap unit 45 caps the nozzle 42a as shown in FIG. 9B (this position is assumed to be a maintenance position). As described above, the up-and-down mechanism 5 moves up the platen unit 16, and the maintenance mechanism 6 is moved up to the maintenance position to perform maintenance of the nozzle 42a, by the movement of the platen unit 16. After capping the nozzle 42a, the cap unit 45 performs maintenance for the nozzle 42a. As explained above, this maintenance operation consists of capping to prevent ink from solidifying by shutting off the ink adhering to the nozzle 42a from the outside air, and drawing ink from the head by suctioning the air in the cap by a not-shown suction pump in the state that the ink is shut off from the outside air.

To record an image after the maintenance, the up-and-down mechanism 5 moves down the platen unit 16 and maintenance mechanism 6. Then, the maintenance positioning pin 42b comes out of the hole 54, and the projection 49b is inserted again into the hole 54. Then, the maintenance moving mechanism 8 moves the maintenance mechanism 6 in the direction of the arrow G, and retracts the maintenance mechanism 6 from the position under the line head 42. Thereafter, the up-and-down mechanism 5 moves the platen unit 16 up, and moves it close to the line head 42. Therefore, the up-and-down mechanism 5, maintenance mechanism 6, maintenance moving mechanism 8, platen unit 16 and line head 42 are returned to the positions to convey the recording medium 60 shown in FIG. 8A.

In this embodiment, positioning in the X and Y directions to the image recording unit 4 when the maintenance mechanism 6 performs maintenance is not limited to the above-mentioned method. For example, the maintenance mechanism 6 may have a positioning hole to insert only the maintenance positioning pin 42b, in addition to the hole 54.

In this embodiment, the maintenance mechanism 6 is arranged on the opposite side of the image recording unit 4 through the recording medium 60 conveying route in the conveying mechanism 3, in the downstream of the recording medium 60 conveying direction in the platen unit 16. The maintenance mechanism 6 is moved to face to the fixed line head 42 in the image recording apparatus 1 to perform maintenance of the line head 42. Therefore, as the line head 42 is not moved, the meniscus is not broken by a vibration generated by the movement of the line head 42 upon the maintenance. As the meniscus is not broken, a high-quality image can be recorded even after maintenance.

Further, the maintenance mechanism 6 is arranged on the opposite side of the image recording unit 4 through the recording medium 60 conveying route in the conveying mechanism 3, in the downstream of the recording medium 60 conveying direction in the platen unit 16. Therefore, in this embodiment, it is possible to provide the first conveying route switching gate 18 as a part of the conveying route, in the space above the maintenance mechanism 6. This permits size reduction in the image recording apparatus 1 at the time of double-sided recording.

As shown in FIG. 7, presence and absence of a nip pressure can be selected by the driven rollers 24a and 25a, depending on the positions of the maintenance mechanism 6 with respect to the support members 29, 30, 31 and 32 in the conveying force selectable part 17. Therefore, in this embodiment, it is possible not to pull the recording medium 60 while the image recording unit 4 is recording an image for the recording medium 60 of various lengths, and a high-quality image can be recorded.

Above the maintenance mechanism 6, a conveying guide 26 is provided to cover the maintenance mechanism 6 when recording an image. Therefore, in this embodiment, the maintenance mechanism 6 is prevented from ingress of dust, and maintenance can be made in good condition with the cap unit 45.

When a jam of the recording medium 60 occurs between the line head 42 and platen unit 16, the up-and-down mechanism 5 can move down the platen unit 16. Therefore, in this embodiment, a jammed medium can be removed without damaging the nozzle surface of the line head 42, or moving the line head 42.

The width of the platen belt 20 is larger than the maximum width of the recording medium 60 used for recording, and the recording medium 60 can be accurately conveyed to the downstream side without skewing.

In this embodiment, when the maintenance mechanism 6 is moved by the maintenance moving mechanism 8, the gear 47 is rotated, and the cap unit 45 moves the guide members 48a and 48b by the rollers 52 and 53 and the pointed portion 49a. However, if the maintenance mechanism 6 can be moved to the position opposite to the nozzle 42a, the invention is not to be limited to this configuration.

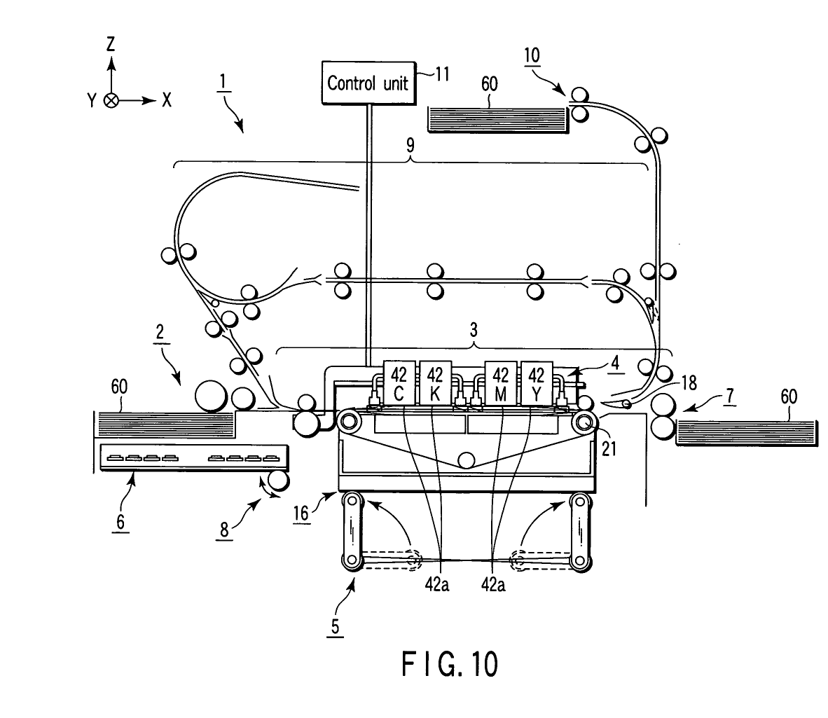

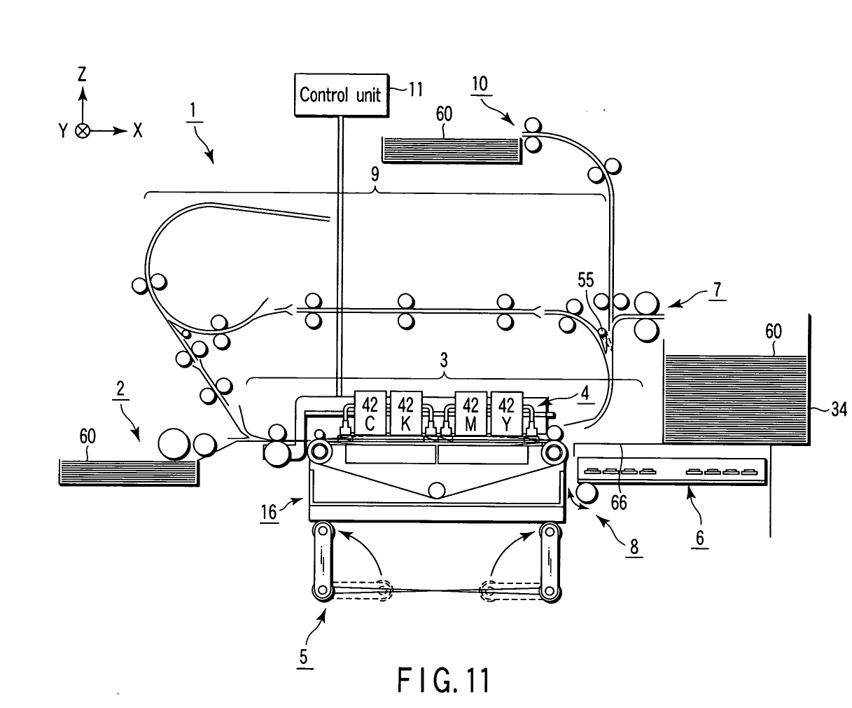

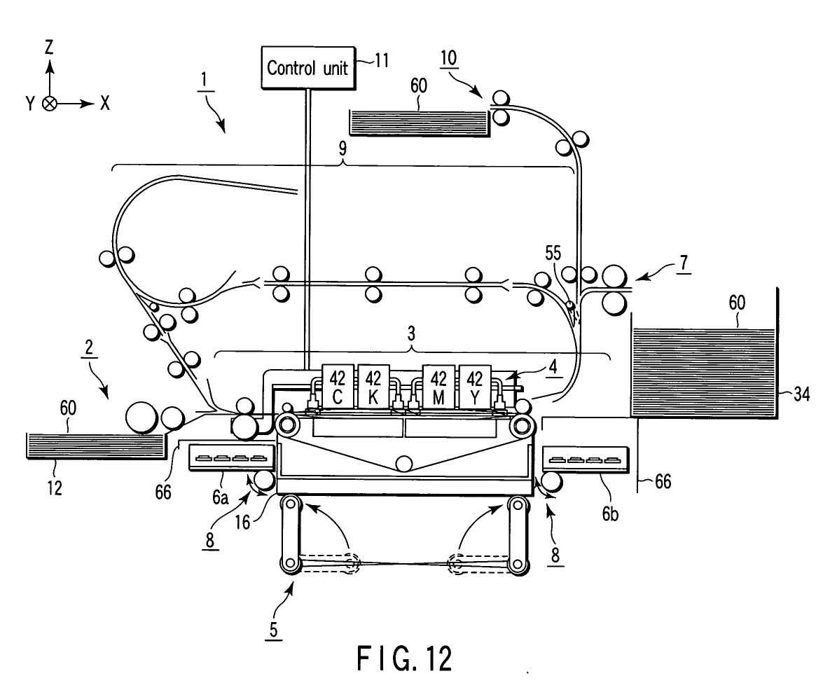

The invention is not to be limited to the above-mentioned embodiment with respect to the positions of the components around the maintenance mechanism 6. Now, first to third modifications of the embodiment will be explained with reference to FIG. 10, FIG. 11 and FIG. 12. In the first to third modifications, the conveying force selectable part 17 is not provided.

FIG. 10 is a schematic diagram showing the configuration of an image recording apparatus 1 in a first modification.

In this modification, the maintenance mechanism 6 is arranged in the upstream of the recording medium conveying direction in the platen unit 16, and at least a part of the maintenance mechanism 6 is arranged under the feeding unit 2. The feeding unit 2 functions also as an outer jacket to prevent the maintenance mechanism 6 from ingress of dust in the air. As the conveying force selectable part 17 is not provided, the first conveying route switching gate 18 is provided in the proximity of the platen belt roller 21 arranged in the most downstream side. In the upper part of the image recording apparatus 1, the double-side reversing mechanism 9 and second discharge unit 10 are provided as in the first embodiment.

In this modification, as at least a part of the maintenance mechanism 6 is arranged under the feeding unit 2, and the first conveying route switching gate 18 is provided in the proximity of the downstream of the platen belt roller 21, the image recording apparatus 1 can be made smaller. The feeding unit 2 can prevent ingress of dust into the maintenance mechanism 6, and the maintenance mechanism 6 can perform maintenance of the nozzle 42a of the line head 42 more cleanly.

FIG. 11 is a schematic diagram showing the configuration of an image recording apparatus 1 in a second modification. In this modification, the upper part of the maintenance mechanism 6 is covered with a dustproof cover 66 as an outer jacket, and a part of the first discharge tray 34 is arranged above the dustproof cover 66. At least a part of the maintenance mechanism 6 is arranged below the first discharge unit 7 (the fist discharge tray 34).

The conveyed recording medium 60 is changed destination to the first discharge tray 34, double-side reversing mechanism 9, or second discharge unit 10, by a third conveying route switching gate 55.

As described above, in this modification, the dustproof cover 66 prevents ingress of dust into the maintenance mechanism 6. By arranging a part of the fist discharge tray 34 above the dustproof cover 66, the image recording apparatus 1 can be made smaller.

FIG. 12 is a schematic diagram showing the configuration of an image recording apparatus 1 in a third modification.

In this modification, the maintenance mechanism 6 is divided into maintenance mechanisms 6a and 6b, which are arranged respectively in the upstream and downstream of the recording medium conveying direction in the platen unit 16. Above the maintenance mechanisms 6a and 6b, a dustproof cover 66 is provided to cover the maintenance mechanisms 6a and 6b. In this modification, the maintenance mechanisms 6a and 6b are moved to face to the line head 42 at the time of maintenance.

As described above, in this modification, the maintenance mechanism 6a is arranged on the opposite side of the image recording unit 4 through the conveying route on the platen unit 16, between the recording medium tray 12 and platen unit 16, and the maintenance mechanism 6b is arranged on the opposite side of the image recording unit 4 through the conveying route on the platen unit 16, between the platen unit 16 and first discharge tray 34. This configuration can downsize the image recording apparatus 1 furthermore.

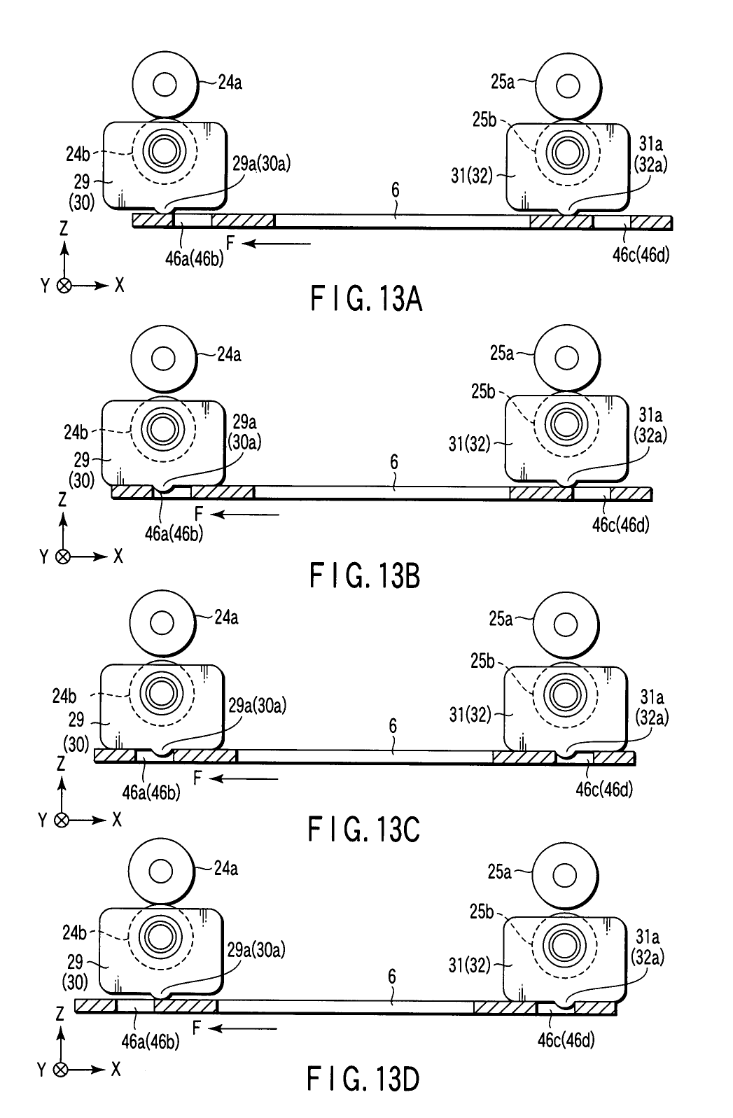

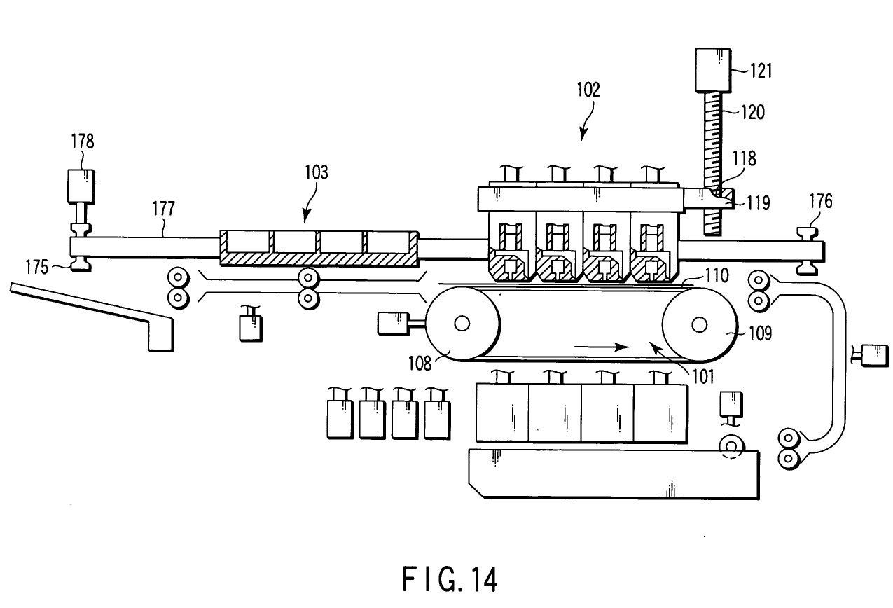

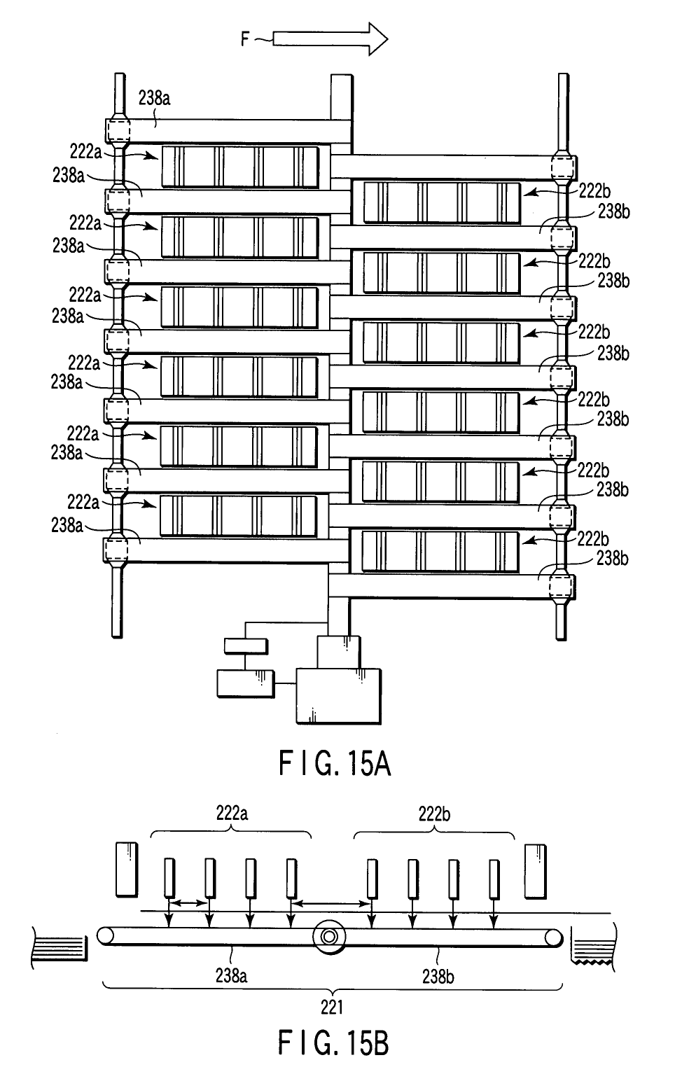

In this embodiment, as shown in FIG. 7, presence and absence of a nip pressure can be selected by moving up/down the driven rollers 24a and 25a. However, the invention may be configured as shown in FIGS. 13A, 13B, 13C and 13D.

In FIGS. 13A, 13B, 13C and 13D, the support members 29, 30, 31 and 32 to support the drive rollers 24b and 25b are moved up/down with respect to the driven rollers 24a and 25a fixed to the apparatus main body.

FIG. 13A shows the case that the projections 29a, 30a, 31a and 32a come out of the slit holes 46a, 46b, 46c and 46d, and the drive rollers 24b and 25b apply a nip pressure to the driven rollers 24a and 25a. FIG. 13B shows the case that the maintenance mechanism 6 is moved from the state shown in FIG. 13A in the direction F, thereby the projections 29a and 30a are inserted into the slit holes 46a and 46b, and the support members 29 and 30 are moved down, the drive roller 24b does not apply a nip pressure to the driven roller 24a, the projections 31a and 32a are still out of the slit holes 46c and 46d, and the drive roller 25b applies a nip pressure to the driven roller 25a. FIG. 13C shows the case that the maintenance mechanism 6 is moved further in the direction F from the state shown in FIG. 13B, the projections 29a, 30a, 31a, and 32a are inserted into the slit holes 46a, 46b, 46c and 46d, and the drive rollers 24b and 25b don't apply a nip pressure to the driven rollers 24a and 25a. FIG. 13D shows the case that the maintenance mechanism 6 is moved further in the direction F from the state shown in FIG. 13C, the projections 29a and 30a come out of the slit holes 46a and 46b, the support members 29 and 30 are moved up, the drive roller 24b applies a nip pressure to the driven roller 24a, the projections 31a, 32a are still inserted into the slit holes 46c and 46d, and the drive roller 25b applies a nip pressure to the driven roller 25a.

The same effect can easily be obtained by that the drive rollers 24b and 25b are moved up, just like the driven rollers 24a and 25b, as described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
a feeding unit to feed a recording medium;
a conveying mechanism having at lest a platen unit to convey the recording medium supplied by the feeding unit;
an up-and-down mechanism to move up and down the platen unit;
an image recording unit which is placed opposite to the platen unit, and provided with a line head for recording an image by ejecting ink from nozzles to the recording medium conveyed;
a maintenance mechanism to perform maintenance for the nozzles of the line head;
a maintenance moving mechanism to move the maintenance mechanism to a position opposite to the line head; and
a discharge unit to discharge the recording medium recorded by the image recording unit, with the last recorded side turned up,
wherein when recording an image, the maintenance mechanism is placed on the opposite side of the image recording unit through a recording medium conveying route in the conveying mechanism, at least one of the upstream side and downstream side of a recording medium conveying direction in the platen unit.

2. The image recording apparatus according to claim 1, wherein when the up-and-down mechanism moves down the platen unit, the maintenance moving mechanism moves the maintenance mechanism to a space formed by the moving down of the platen unit.

3. The image recording apparatus according to claim 1, wherein when the maintenance mechanism performs maintenance of the nozzles, the up-and-down mechanism moves down the platen unit, and the maintenance moving mechanism moves the maintenance mechanism to a space formed by the moving down of the platen unit, and moves the maintenance mechanism to a position opposite to the nozzles, the up-and-down mechanism moves up the platen unit, and the maintenance mechanism is moved by the moving platen unit to a position to perform maintenance of the nozzles.

4. The image recording apparatus according to claim 1, wherein at least a part of the maintenance mechanism is placed below the feeding unit.

5. The image recording apparatus according to claim 1, wherein at least a part of the maintenance mechanism is placed below the first discharge unit.

6. The image recording apparatus according to claim 1, wherein an outer jacket to cover the maintenance mechanism when recording an image is provided above the maintenance mechanism.

7. The image recording apparatus according to claim 1, further comprising a double-side reversing mechanism which reverses and re-feeds the recording medium to the image recording unit, in order to record an image on both sides of the recording medium.

8. The image recording apparatus according to claim 1, wherein the platen unit has a belt for conveying the recording medium, and the width of the belt is larger than the maximum width of the recording medium supplied from the feeding unit.

9. An image recording apparatus comprising:
a feeding unit to feed a recording medium;
a conveying mechanism having at lest a platen unit to convey a recording medium supplied by the feeding unit to a downstream side by rotating a belt with the width larger than the maximum width of the recording medium;
an up-and-down mechanism to move up and down the platen unit;
an image recording unit which is placed opposite to the platen unit, and provided with a line head for recording an image by ejecting ink from nozzles to a conveyed recording medium;
a maintenance mechanism to perform maintenance for nozzles of a line head;
a maintenance moving mechanism to move a maintenance mechanism to a position opposite to a line head;
a double-side reversing mechanism which reverses and re-feeds the recording medium in order to record on both sides of a recording medium; and
a discharge unit to discharge the recording medium recorded by the image recording unit, with the last recorded side turned up,
wherein when recording an image, the maintenance mechanism is placed on the opposite side of the image recording unit through a recording medium conveying route in the conveying mechanism, at least one of the upstream side and downstream side of a recording medium conveying direction in the platen unit.

10. The image recording apparatus according to claim 9, wherein at least a part of the maintenance mechanism is placed below the feeding unit.

11. The image recording apparatus according to claim 9, wherein at least a part of the maintenance mechanism is placed below the discharge unit.

12. The image recording apparatus according to claim 9, wherein the conveying mechanism has a conveying route switching gate which switches the recording medium conveying route to the double-side reversing mechanism or discharge unit, and
the maintenance mechanism is placed below the conveying route switching gate.
